(19) United States
(12) Patent Application Publication
(10) Pub. No.: US 2026/0007108 A1
(43) Pub. Date: Jan. 8, 2026

(54) GARDEN SHEARS STRUCTURE

(71) Applicant: HO CHENG GARDEN TOOLS CO., LTD., Fu Shing Hsiang (TW)

(72) Inventor: Yao-Chung Huang, Fu Shing Hsiang (TW)

(21) Appl. No.: 18/766,396

(22) Filed: Jul. 8, 2024

(51) Int. Cl. A01G 3/02

(52) U.S. Cl. CPC A01G 3/021

(57) ABSTRACT

A garden shears structure has a first cutting member, an anvil, a second cutting member, a bolt, and a plurality of pivoting members. The second cutting member has a blade base, a driving member, the two connecting bar and two positioning plates. The first cutting member has two anvil bases with an arced long aperture, a first anvil base aperture and a second anvil base aperture. An opening is formed on the lower side of the blade base which has a first blade base aperture and a second blade base aperture. The driving member has two protrusions. Aa first driving member aperture and a second driving member aperture are disposed through the two protrusion respectively. A first connecting bar aperture and a second connecting bar aperture are disposed on the connecting bar. The positioning plate has a first positioning plate aperture and a second positioning plate.

### BACKGROUND OF THE INVENTION

### Field of Invention

The present invention relates to a garden shears structure.

### Description of the Related Art

Currently, most of common gardening shears have two opposite cutting blades connected to long rod-shaped handles and a perforation is provided in the middle section, and cutting blades are positioned and secured in a pivot position with a nut and a bolt. When force is applied to the handle, the nut and bolt can be used as the axis, causing the cutting blades to open and close for cutting.

However, the above conventional structure still has the following problems in practical application: the garden shears directly use the pivot point of the screw as the fulcrum, and cannot produce the force-increasing effect, making the garden shears more difficult to use. Also, the two cutting blades are only pivoted together through screws, which makes the two cutting blades are prone to be unstable with each other operations.

Therefore, it is desirable to provide a garden shears structure to mitigate and/or obviate the aforementioned problems.

### SUMMARY OF THE INVENTION

An objective of present invention is to provide a garden shears structure, which is capable of improving the above-mention problems.

In order to achieve the above-mentioned objective, a garden shears structure has a first cutting member, an anvil, a second cutting member, a bolt, and a plurality of pivoting members. The second cutting member has a blade base, a driving member, two connecting bars, and two positioning plates.

The first cutting member has two anvil bases respectively with an arced long aperture, a first anvil base aperture and a second anvil base aperture, the two anvil bases securing the anvil and providing a containing space therebetween for accepting the second cutting member.

The blade base has an opening with a first blade base aperture and a second blade base aperture.

The driving member has two protrusions with a first driving member aperture and a second driving member aperture.

Each of the connecting bars has a first connecting bar aperture and a second connecting bar aperture; the two connecting bars respectively push against the blade base and the driving member, bolts are mounted through the second connecting bar aperture and the first driving member aperture, the driving member and the connecting bars are connected together, and a pivoting member is mounted at the arced long apertures of the two anvil bases, the first connecting bar aperture of the two connecting bars, and the first blade base aperture of the blade base, such that the driving member is capable of being rotated along the arced long aperture in the containing space via the connecting bars to drive the blade base to open or close.

The positioning plate has a first positioning plate aperture and a second positioning plate aperture, the two positioning plates respectively push against the blade base and the driving member, the first positioning plate aperture is aligned with the first anvil base apertures of the two anvil bases and the second driving member apertures of the driving member, the second positioning plate aperture is aligned with the second anvil base apertures of the two anvil bases and the second blade base aperture of the blade base, and two pivoting members are mounted with the first anvil base aperture and the second anvil base aperture to assemble the second cutting member in the containing space.

Other objects, advantages, and novel features of invention will become more apparent from the following detailed description when taken in conjunction with the accompanying drawings.

### BRIEF DESCRIPTION OF THE DRAWINGS

FIG. 1 is a three-dimensional combination of a preferred embodiment according to the prevent invention.

FIG. 2 is a three-dimensional exploded view of the preferred embodiment according to the prevent invention.

FIG. 3 is a combined plan view of the preferred embodiment according to the prevent invention.

FIG. 4 is a combined cross-sectional view of the preferred embodiment according to the prevent invention

FIG. 5 is a combined cross-sectional view from another angle of the preferred embodiment according to the prevent invention

FIG. 6 is a state diagram of the blade base opening in the preferred embodiment according to the prevent invention

FIG. 7 is a cutting state diagram of the preferred embodiment according to the prevent invention.

### DETAILED DESCRIPTION OF PREFERRED EMBODIMENT

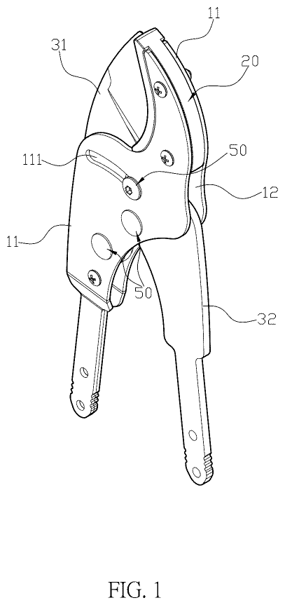

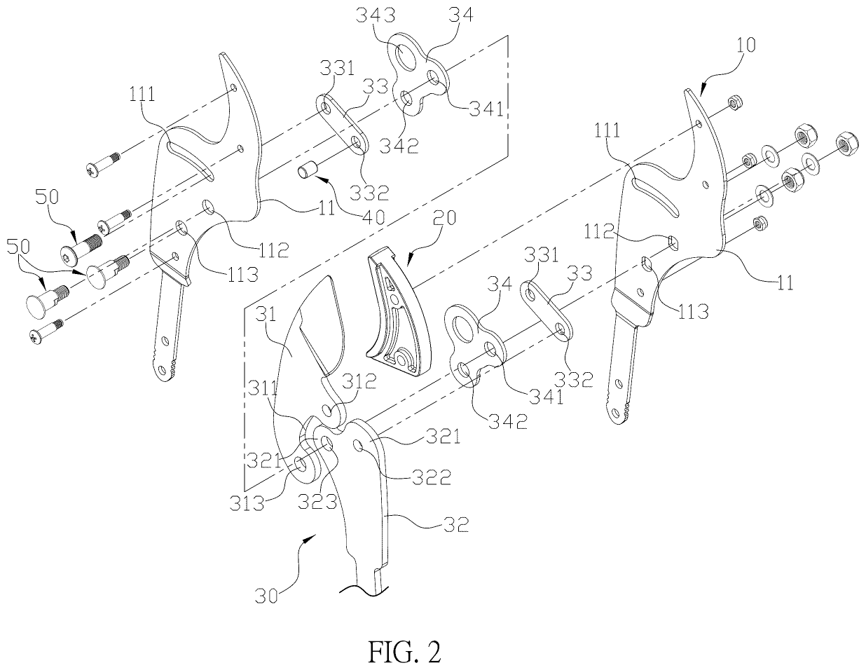

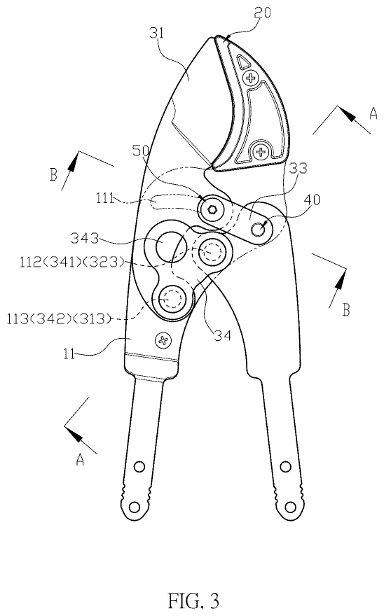

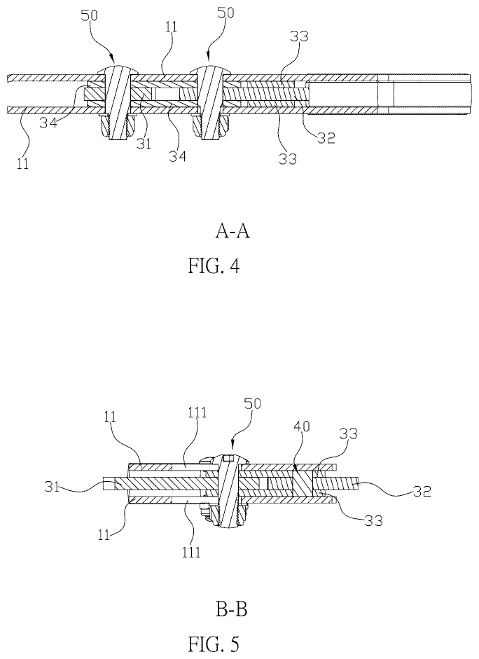

First, please refer to FIGS. 1-5. A garden shears structure comprises: a first cutting member 10, an anvil 20, a second cutting member 30, a bolt 40 and a plurality of pivoting members 50. The second cutting member 30 comprises a blade base 31, a driving member 32, two connecting bars 33 and two positioning plates 34. The first cutting member 10 has two anvil bases 11 respectively with an arced long aperture 111, a first anvil base aperture 112 and a second anvil base aperture 113, for securing the anvil 20 and providing a containing space 12 therebetween for accepting the second cutting member 30. The blade base 31 has an opening 311 with a first blade base aperture 312 and a second blade base aperture 313. The driving member 32 has two protrusion 321 parted from each other with a first driving member aperture 322 and a second driving member aperture 323. Each of the connecting bar 33 has a first connecting bar aperture 331 and a second connecting bar aperture 332. When the two connecting bar 33 respectively push against the blade base 31 and the driving member 32, bolts 40 are mounted through the second connecting bar aperture 332 and the first driving member aperture 322, the driving member 32 [symbol] the connecting bar 33 are connected together, and a pivoting member 50 is mounted at the arced long aperture 111 of the two anvil base 11, the first connecting bar aperture 331 of the two connecting bar 33 and the first blade base aperture 312 of the blade base 31, such that the driving member 32 is capable of being rotated along the arced long aperture 111 in the containing space 12 via the connecting bars 33 to drive the blade base 31 to open or close. The positioning plate 34 has a first positioning plate aperture 341 and a second positioning plate aperture 342. The two positioning plate 34 respectively push against the blade base 31 and the driving member 32, the first positioning plate aperture 341 is aligned with the first anvil base aperture 112 of the two anvil base 11 and the second driving member aperture 323 of the driving member 32, the second positioning plate aperture 342 is aligned with the second anvil base aperture 113 of the two anvil base 11 and the second blade base aperture 313 of the blade base 31, and two pivoting member 50 are mounted with the first anvil base aperture 112 and the second anvil base aperture 113 to assemble the second cutting member 30 in the containing space 12.

Furthermore, the anvil base 11 of the first cutting member 10 and the driving member 32 of the second cutting member 30 both respectively assembled with a handle (not shown).

In addition, the anvil 20 is secured between the two anvil bases.

Furthermore, the positioning plate 34 further comprises a through aperture 343 between the first positioning plate aperture 341 and the second positioning plate aperture 342, for exiting chip excess to prevent the second cutting member 30 from being jammed and reduce operation resistance.

Moreover, the pivoting member 50 comprises a bolt and a nut.

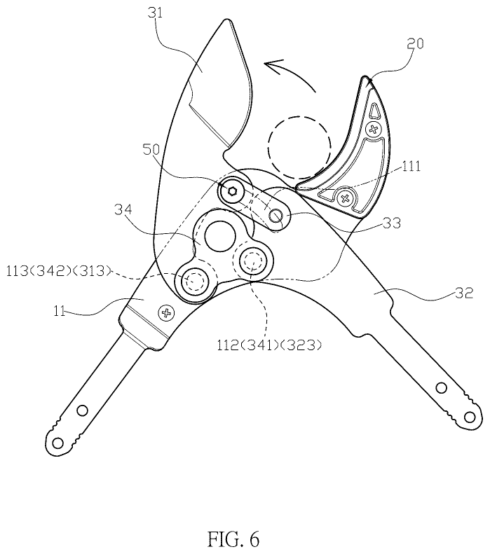

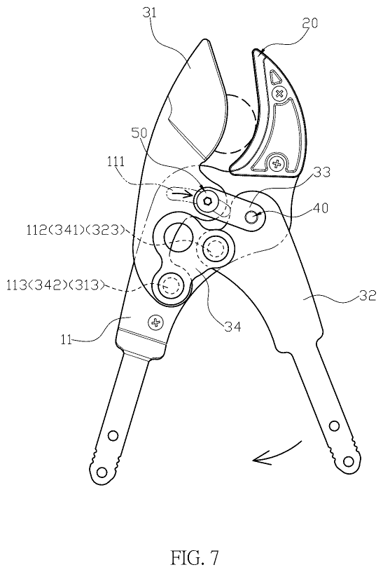

As shown in FIG. 6, in order to prune flowers, trees and other objects, a user holds the two handles with both hands and apply outwardly force, so that the driving member 32 is able to rotate along the arced long aperture 111 to push the connecting bar 33, so that the blade base 31 open to a greater extent through the connection with the connecting bar 33. When the user presses the two handles toward to each other with both hands, as shown in FIG. 7, the extension of the connecting bar 33 can be used to produce a force-increasing effect, so that the operation of the blade base 31 can be more labor-saving. In this way, more comprehensive application such as thicker branches and leaves can be cut to achieve gardening pruning.

With the above-mentioned structure of the specific embodiment, the following benefits can be obtained: first, the garden shear is capable of producing a force-increasing effect during operations, and also capable of allowing trimming operations on thicker objects, which is easier to use, and comprehensive time-saving and labor-saving and; secondly, the installation of the positioning plate 34 and the connecting bar 33 can make the shearing action of the driving member 32 and the blade base 31 more stable, and can also prevent the driving member 32 from being damaged while the shearing force is too strong; last, the positioning plate 34 can reinforce the installation of the blade base 31 and the driving member 32, and can also effectively disperse the stress, allowing t overall strength of the gardening shear can be significantly improved.

Although the present invention has been explained in relation to its preferred embodiment, it is to be understood that many other possible modifications and variations can be made without departing from the spirit and scope of invention as hereinafter claimed.

What is claimed is:

1. A garden shears structure comprising: a first cutting member, an anvil, a second cutting member, a bolt, and a plurality of pivoting members, the second cutting member comprising: a blade base, a driving member, two connecting bars, and two positioning plates; wherein:
the first cutting member has two anvil bases respectively with an arced long aperture, a first anvil base aperture and a second anvil base aperture, the two anvil bases securing the anvil and providing a containing space therebetween for accepting the second cutting member;
the blade base has an opening with a first blade base aperture and a second blade base aperture;
the driving member has two protrusions with a first driving member aperture and a second driving member aperture;
each of the connecting bars has a first connecting bar aperture and a second connecting bar aperture; the two connecting bars respectively push against the blade base and the driving member, bolts are mounted through the second connecting bar aperture and the first driving member aperture, the driving member and the connecting bars are connected together, and a pivoting member is mounted at the arced long apertures of the two anvil bases, the first connecting bar aperture of the two connecting bars, and the first blade base aperture of the blade base, such that the driving member is capable of being rotated along the arced long aperture in the containing space via the connecting bars to drive the blade base to open or close; and
the positioning plate has a first positioning plate aperture and a second positioning plate aperture, the two positioning plates respectively push against the blade base and the driving member, the first positioning plate aperture is aligned with the first anvil base apertures of the two anvil bases and the second driving member apertures of the driving member, the second positioning plate aperture is aligned with the second anvil base apertures of the two anvil bases and the second blade base aperture of the blade base, and two pivoting members are mounted with the first anvil base aperture and the second anvil base aperture to assemble the second cutting member in the containing space.

2. The garden shears structure as claimed in claim 1, wherein the anvil is secured between the two anvil bases.

3. The garden shears structure as claimed in claim 1, wherein the positioning plate further comprises a through aperture between the first positioning plate aperture and the second positioning plate aperture.

4. The garden shears structure as claimed in claim 1, wherein the pivoting member comprises a bolt and a nut.
